(19) United States
(12) Patent Application Publication
(10) Pub. No.: US 2019/0039633 A1
(43) Pub. Date: Feb. 7, 2019

(54) RAILROAD TRACK ANOMALY DETECTION

(71) Applicant: PANTON, INC., Houston, TX (US)

(72) Inventor: Saishi Frank LI, Sugar Land, TX (US)

(21) Appl. No.: 16/052,410

(22) Filed: Aug. 1, 2018

Related U.S. Application Data
(60) Provisional application No. 62/540,158, filed on Aug. 2, 2017.

(51) Int. Cl. B61L 23/04; G06T 7/00; G06T 7/55; G06K 9/00; G01S 17/89

(52) U.S. Cl. CPC B61L 23/047; B61L 23/041; G06T 7/001; G06T 2207/30248; G06K 9/00791; G01S 17/89; G06T 2207/30108; G06T 7/55

(57) ABSTRACT

Techniques are disclosed for detecting and reporting railroad track anomalies. In one embodiment, a track inspection application is configured to receive images (or other sensor data) depicting a railroad track captured by cameras mounted on a train, compare the captured images with corresponding reference images (or other sensor data) captured from substantially the same locations and vantage points, and detect anomalies in the railroad track represented by differences between the captured images and corresponding reference images. In another embodiment, the inspection application may generate a three-dimensional (3D) model of the railroad track based on depths determined through, e.g., triangulation, and determine the railroad track's geometry from the 3D model. The inspection application may then detect anomalies associated with the track geometry, such as an incorrect distance between track rails or an incorrect overall location of the track, based on differences between the determined track geometry and a stored track geometry.

### CROSS-REFERENCE TO RELATED APPLICATIONS

This application claims priority to U.S. provisional application having Ser. No. 62/540,158, filed on Aug. 2, 2017, which is hereby incorporated by reference in its entirety.

### BACKGROUND

### Field of the Invention

The present invention relates generally to computer image processing and, in particular, to automated railroad track anomaly detection.

### Description of the Related Art

Damage to railroad tracks and changes to track geometry can reduce the efficiency of the railroad tracks and create safety hazards. Damage to the power lines above electric trains can also be problematic. Traditionally, railroad tracks and power lines have been inspected manually, and repairs performed as needed based on such inspections. However, such manual inspections are labor-intensive. In addition, inspectors can overlook track and power line problems that require repair.

### SUMMARY

One embodiment provides a method for detecting anomalies affecting a railroad track. The method generally includes receiving sensor data captured by one or more sensors mounted on a train, the sensor data being captured as the train traverses the railroad track. The method further includes normalizing the received sensor data to match corresponding reference sensor data. In addition, the method includes detecting the anomalies based, at least in part, on differences between the normalized sensor data and the corresponding reference sensor data

Further embodiments provide a non-transitory computer-readable medium that includes instructions that, when executed, enable a computer to implement one or more aspects of the above method, and a computer system programmed to implement one or more aspects of the above method.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an approach for capturing images used to detect railroad track anomalies, according to an embodiment.

FIG. 2 illustrates a system in which an embodiment may be implemented.

FIG. 3 illustrates an example of normalizing an image, according to one embodiment.

FIG. 4 illustrates an example comparison of a captured image to a reference image, according to an embodiment.

FIG. 5 illustrates a method for detecting railroad track anomalies, according to an embodiment.

### DETAILED DESCRIPTION OF EXEMPLARY EMBODIMENTS

Embodiments of the invention provide techniques for detecting railroad track anomalies. In one embodiment, a track inspection application is configured to receive sensor data that is captured by sensor(s) mounted on a train as the train traverses a railroad track. For example, the sensor(s) may include cameras mounted on the front and back of the train that are used to capture, from multiple vantage points, images depicting various sections of the railroad track and/or overhead power lines, and the track inspection application may compare each of the captured images to a corresponding reference image captured from substantially the same location and vantage point in order to detect as anomalous differences between the captured image and the corresponding reference image. The detected anomalies may be indicative of damage to the railroad tracks and/or power lines, foreign objects, among other things. Prior to comparing a captured image and a corresponding reference image, the track inspection application may correct for differences in camera angle/position and color/lighting conditions between the images by normalizing the captured image to match the corresponding reference image. In addition, the track inspection application may generate a three-dimensional (3D) model of the railroad track based on depths determined through triangulation, and determine the railroad track's geometry from the 3D model. As used herein, track geometry refers to the railroad track's 3D layout and associated measurements. The track inspection application may detect anomalies in the track geometry, such as an incorrect distance between track rails or an incorrect overall location of the railroad track, based on differences between the determined track geometry and a stored track geometry.

Herein, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a railroad track inspection management application) or related data available in the cloud. For example, a railroad track inspection application could execute on a computing system in the cloud and process videos and/or images to detect railroad track and power line anomalies and track geometry issues, according to techniques disclosed herein. Doing so allows a user to access this information from any computing system attached to a network connected to the cloud (e.g., the Internet).

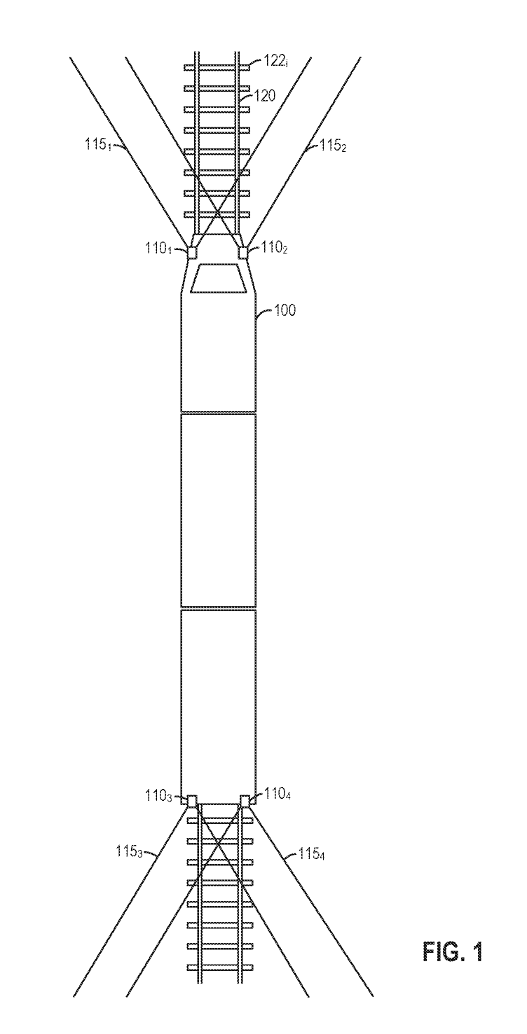

Referring now to FIG. 1, a diagram illustrating an approach for capturing images used to detect railroad track anomalies is shown. As shown, cameras 110₁₋₄ mounted on a train 100 capture images of a railroad track 120 from multiple vantage points. Illustratively, two cameras 110₁₋₂ are mounted on the front of the train 100 and another two cameras 110₃₋₄ are mounted on the back of the train 100. Although two cameras are shown facing each of the front and the back of the train, it should be understood that any number of cameras (e.g., two plenoptic cameras on the front and back of the train, respectively) may be used, and the cameras may be placed in any suitable position capable of capturing images of the front and back of the train 100, including on the front and back, on the top or bottom, and/or on the sides of the train 100. In addition, although photographic cameras 110₁₋₄ are shown for illustrative purposes, in alternative embodiments, other types of sensors may be used in lieu of or in addition to photographic cameras. For example, thermal camera(s), LIDAR (Light Detection and Ranging), and/or or other sensors may be used to capture sensor data from the front and back of a train. It should be understood that some types of sensors may be capable of capturing frequencies of light that are not visible and that photographic cameras cannot capture.

As shown, the front-facing 110₁₋₂ and back-facing 110₃₋₄ cameras capture images of both sides of the railroad track 120 so that, e.g., damages to and objects on both (the front and the back) sides of the sleepers 122ᵢ can be detected. Although described with respect to cameras 110₁₋₄ that capture the railroad track 120, in some embodiments cameras and/or other sensors may also be positioned so as to capture the power lines above a train, which may also experience damage. In operation, the cameras 110₁₋₄ may continuously capture images, either individually or as the frames of a video. In one embodiment, the cameras 110₁₋₄ may be high-quality cameras that each captures at least 20 images per second. As a result, the cameras 110₁₋₄ are able to capture images without skipping any sections of the railroad track 120, even when the train 100 travels up to 400 kilometers per hour. Further, it should be understood that use of the train-mounted cameras 110₁₋₄ permits images to be captured and analyzed during normal operation of the train 100.

As shown, the fields of view 115₁₋₂ of the front-facing cameras 110₁₋₂ overlap, as do the fields of view 115₃₋₄ of the back-facing cameras 110₃₋₄. Such overlapping fields of view permit a track inspection application to estimate depths in the captured images through triangulation and to generate a 3D model based on the estimated depths for detecting track geometry anomalies, as described in greater detail below. In alternative embodiments, other techniques such as LIDAR depth maps may be used in lieu of images from overlapping cameras. In addition to capturing the images themselves, the cameras 110₁₋₄ (or another device) may record location information, such as Global Positioning System (GPS) coordinates associated with each of the captured images.

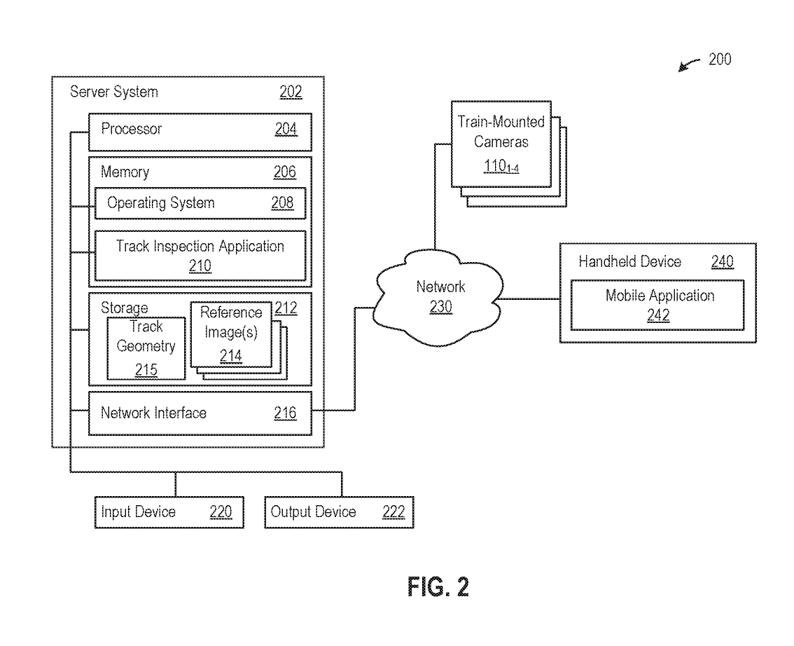

In one embodiment, images captured by the cameras 110₁₋₄ and associated GPS coordinates are uploaded to a server computer in which a track inspection application (e.g., track inspection application 210 shown in FIG. 2) runs. In turn, the track inspection application compares (e.g., by subtracting) the captured images with stored reference images of the same sections of the track 120 (or overhead power lines) that were previously taken from substantially the same GPS coordinates and vantage point, and the track inspection application detects anomalies in the track 120 (or overhead power lines) based on the comparison of the captured and reference images. As described, the anomalies may correspond to damage to the tracks, foreign objects, and so on. The track inspection application may further generate a report detailing the detected anomalies and push the same to a user's handheld device, in order to notify the user of the anomalies and allow appropriate remedial measures to be taken.

In addition to detecting anomalies by comparing the captured and reference images, the track inspection application may also detect anomalies based on differences between a track geometry determined from the captured images and a stored track geometry. It should be understood that the track geometry may change over time as a result of weather, erosion, etc., and the track inspection application may compare the determined and stored track geometries to detect such changes. As described, the train-mounted cameras' 110₁₋₄ overlapping fields of view permit the estimation of depth through triangulation. In one embodiment, the track inspection application may generate a 3D model based on the estimated depths, make measurements using the 3D model and received GPS information, and compare those measurements with measurements in the stored track geometry. For example, the distance between track rails, which is sometimes referred to as track gauge, may be measured by converting a distance between points representing the track rails in the 3D model to a real-world distance based on a conversion factor. The track inspection application may then compare such a measured distance with a stored distance and report a difference between the measured and stored distances as an anomaly.

FIG. 2 illustrates a system for detecting and reporting railroad track anomalies, according to an embodiment. As shown, the system 200 includes a server system 202 that is in communication with the train-mounted cameras 110₁₋₄ and a handheld device 240 via a network 230. In general, the network 230 may be a telecommunications network and/or a wide area network (WAN). In one embodiment, the network 230 may be the Internet.

The server 202 generally includes a processor 204 connected via a bus to a memory 206, a network interface device 210, a storage 212, an input device 220, and an output device 222. The server system 202 is under the control of an operating system 208. Examples of operating systems include the UNIX® operating system, versions of the Microsoft Windows® operating system, and distributions of the Linux® operating system. More generally, any operating system supporting the functions disclosed herein may be used. The processor 204 is included to be representative of a single central processing unit (CPU), multiple CPUs, a single CPU having multiple processing cores, one or more graphics processing units (GPUs), some combination of CPU(s) and GPU(s), and the like. The memory 206 may be a random access memory. The network interface device 216 may be any type of network communications device allowing the server system 202 to communicate with the handheld device 240 via the network 230.

The input device 220 may be any device for providing input to the server system 202. For example, a keyboard and/or a mouse may be used. The output device 222 may be any device for providing output to a user of the server system 202. For example, the output device 222 may be any conventional display screen or set of speakers. Although shown separately from the input device 220, the output device 222 and input device 220 may be combined. For example, a display screen with an integrated touch-screen may be used.

Illustratively, the memory 206 includes a track inspection application 210. The track inspection application 210 provides a software application configured to receive images and/or videos from the train-mounted cameras 110₁₋₄ (which may be other types of sensors such as LIDAR in alternative embodiments) and process the images and/or videos to detect track anomalies, including track geometry issues. In one embodiment, the track inspection application 210 may be configured to normalize received images that are captured by train-mounted cameras, detect anomalies based on differences between the normalized images and the corresponding stored reference images 214 as well as track geometry issues based on differences between a determined track geometry and a stored track geometry 215, and generate and push a report detailing the detected anomalies and track geometry issues to a mobile application 242 running in the handheld device 240. In alternative embodiments, the generated report may be sent to the handheld device 240 using other techniques (e.g., a pull technique as opposed to a push technique) and/or the report may be sent to some other device, such as a personal computer or laptop.

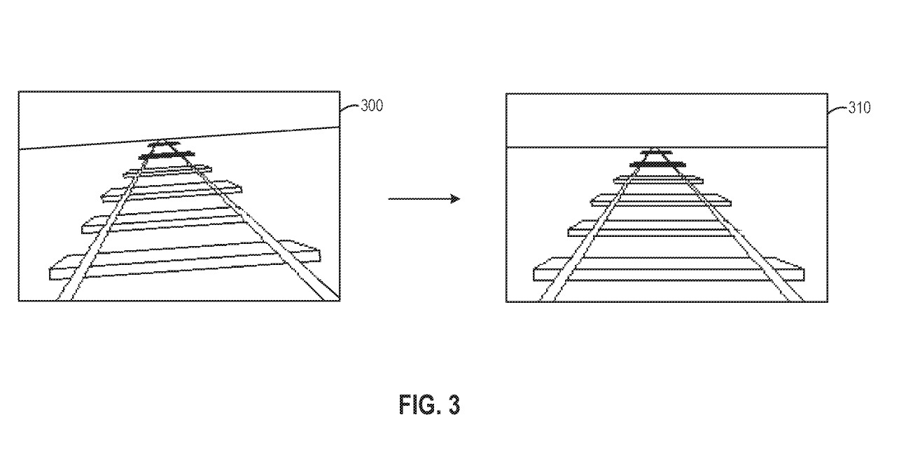

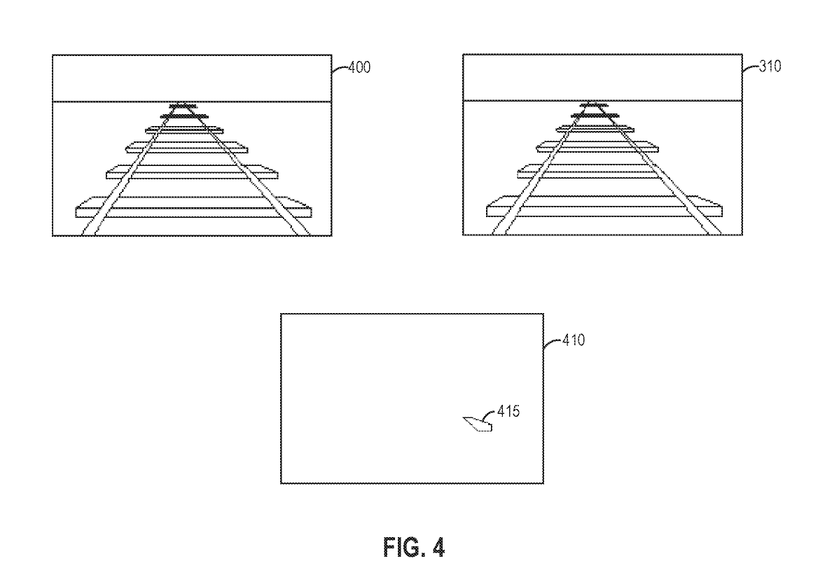

FIG. 3 illustrates an example of normalizing an image, according to one embodiment. As described, a received image 300 captured using a train-mounted camera may be normalized to align with a corresponding reference image (or images) previously captured (and stored) by a train-mounted camera at substantially the same location and vantage point as the camera that captured the received image 300. Although images depicting a train track are shown for illustrative purposes with respect to FIGS. 3-4, it should be understood that the normalization and comparison processing techniques disclosed herein are also applicable to other captured images, such as captured images that depict overhead power lines. Further, although images captured by a photographic camera are shown for illustrative purposes, normalization and comparison to reference data may also be performed for other types of captured sensor data, such as thermal camera images and LIDAR data.

In one embodiment, the normalization applied to match the received image 300 with the corresponding reference may include transforming the received image 300 through scaling, translation, rotation, skew, and the like to correct for differences in camera angle and position. For example, the image analysis application 310 may transform the received image 300 by matching features (e.g., RANSAC features) of pixels and/or regions in the image 300 to features in the corresponding reference image, determining a mapping between the received image 300 and the reference image that takes the matching features in the received image 300 to those in the reference image, and applying the mapping to transform the received image 300.

In one embodiment, the normalization process may also include removing light condition effects. For example, to account for color/lighting differences between the image 300 and a reference image, the track inspection application may adjust the pixel values of the image 300 so that a histogram of such values matches a histogram for the reference image. Further, the reference image that the image 300 is compared with may be taken at a similar time of day as the image 300, and the images themselves may be captured with the help of artificial lighting (e.g., the frontal light of the train) at night. After normalization, the image 300 and the reference image should be substantially aligned, and the track inspection application may determine differences between such images by comparing the normalized image 310 to the corresponding reference image, as described in greater detail with respect to FIG. 4.

FIG. 4 illustrates an example of the image comparison process, according to one embodiment. Illustratively, the normalized image 310 depicting the railroad track is being compared to a corresponding reference image 400. As described, the reference image 400 may be an image captured earlier by a train-mounted camera at substantially the same location and vantage point as the camera that captured the normalized image 310. For example, the track inspection application may select, from a database of stored reference images, one of the stored reference images that was captured by a camera mounted on a train at a same position (e.g., on the same front left camera 110₁) as, and at a closest GPS coordinate to, the normalized image 310 (which, of course, is associated with the same GPS coordinates and train-mounting position as the received image 300). In one embodiment, images including those used as reference images may be captured using train-mounted cameras during the normal operation of trains. In addition, the images stored as reference images may be updated periodically, such as every month, year, or any other time period, in order to reflect changes to the track environment over time. In an alternative embodiment, the reference images may include standard images depicting railroad track components such as sleepers in undamaged condition (e.g., taken when the track was new) that are compared, either individually or together, against the railroad track components shown in captured images.

In one embodiment, the track inspection application 210 compares the normalized image 310 with the corresponding reference image 400 by subtracting the reference image 400 from the normalized image 310 (and/or vice versa) to obtain a delta image 410 showing differences between the two images. Such differences may indicate anomalies, such as damage to the tracks or foreign objects on the tracks, that have appeared since the reference image 400 was taken. Although described herein primarily with respect to a comparison involving a subtraction of images, in alternative embodiments, other types of comparisons may be performed, such as a comparison utilizing a normalized cross correlation in the Fourier domain.

Illustratively, a missing portion 415 of a sleeper of the railroad track remains in the delta image 410 after the reference image 400 is subtracted from the normalized image 310. In one embodiment, the track inspection application 210 may automatically assign a unique identifier (ID) to each sleeper of the railroad track, and the track inspection application 210 may then detect anomalies as differences between the depictions of the same sleepers (i.e., sleepers having the same IDs) in captured and reference images, such as the missing portion 415 of the sleeper. IDs may be assigned to sleepers based on the locations of the sleepers in captured images and the GPS coordinates of those images by, e.g., counting the sleepers in the captured images and assigning each counted sleeper a unique ID.

In one embodiment, the track inspection application 210 may generate a report of anomalies detected through the comparison process (and the locations of the anomalies and IDs of the associated sleepers, if any), and then push such a report to the mobile application 242 so that a user can confirm the anomalies and take remedial actions, as necessary. In another embodiment, a machine learning model, such a convolutional neural network, may be trained to classify different types of anomalies, such as cracks, dents, other surface anomalies, and the like. In such a case, the image analysis application 210 may employ such a trained machine learning model to classify the type of damage that each identified anomaly represents, and the image analysis application 210 may also indicate the types of damages output by the machine learning model in the report that is generated and pushed to the mobile application 242.

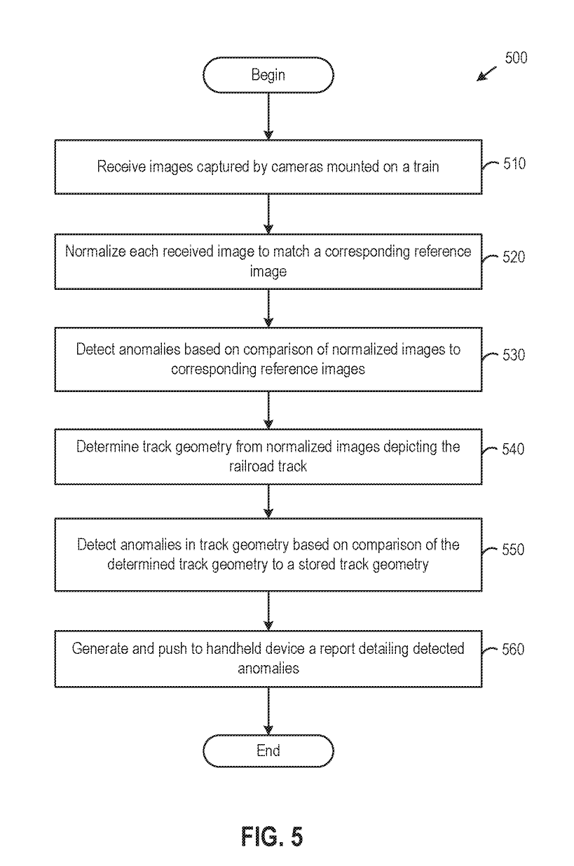

FIG. 5 illustrates a method 500 for detecting railroad track anomalies, according to an embodiment. As shown, the method 500 begins at step 510, where the track inspection application 210 receives images captured by cameras mounted on a train. The train-mounted cameras may include one or more front-facing cameras mounted on the train, as well as one or more backward-facing cameras mounted on the train, such as the front and backward-facing cameras with overlapping fields of view in the configuration shown in FIG. 1. Such train-mounted cameras may be positioned so as to capture images depicting the railroad track below the train and/or images depicting power lines above the train. Any suitable types of cameras may be used, such as photographic and/or thermal cameras. Further, some embodiments may employ other types of sensors, such as LIDAR, in lieu of or in addition to cameras. In general, one or more sensors may be used to capture data in front and behind the train.

At step 520, the track inspection application 210 normalizes each received image (or other sensor data) to match a corresponding reference image (or other sensor data). As described, the corresponding reference image may be a stored image previously taken by a train-mounted camera from substantially the same location (e.g., GPS coordinates) and vantage point, and the images used as reference images may also be updated periodically, such as monthly or yearly. Alternatively, the reference images may include standard images depicting railroad track components such as sleepers in undamaged condition that are compared, either individually or together, against the railroad track components shown in captured images. In one embodiment, the normalization applied to match a received image with a corresponding reference image may include (1) transforming the received image through scaling, translation, rotation, skew, and the like to correct for differences in camera angle and position; and (2) adjusting the pixel values to correct for differences in color/lighting conditions between the received image and the reference image, as described above with respect to FIG. 3. In addition, the track inspection application 210 may use a reference image taken at a similar time of day as the received image so that color/lighting conditions are similar to begin with, and the images themselves may be captured with the help of artificial lighting (e.g., the frontal light of the train) at night.

At step 530, the track inspection application 210 detects anomalies based on a comparison of the normalized images to the corresponding reference images. In one embodiment, the track inspection application 210 may subtract the normalized images from their corresponding reference images and detect as anomalies any sufficiently large regions whose pixel values differ by more than a threshold amount to minimize the detection of unwanted noise. In alternative embodiments, other comparisons may be used to detect differences between the normalized and the corresponding references images, such as a comparison utilizing a normalized cross correlation in the Fourier domain. Other types of sensor data collected using thermal cameras, LIDAR, etc. may similarly be normalized and compared with reference data.

In one embodiment, the track inspection application 210 may assign a unique ID to each sleeper of the railroad track and detect anomalies associated with each sleeper, as indicated by differences between the sleepers having the same IDs depicted in the normalized images and in corresponding reference images.

In another embodiment, techniques such as artificial intelligence (AI) may be applied to remove random noise that results from, e.g., track ballast rocks moving around. For example, the AI may be trained using previously captured images to distinguish between statistically common noise that is frequently observed and abnormal (i.e., statistically uncommon) changes that should be detected as anomalies.

At step 540, the track inspection application 210 determines the railroad track's geometry from the normalized images depicting the railroad track (or from the original received images). In one embodiment, the track inspection application 210 may match pixels and/or regions in each image captured by a front-facing camera with pixels and/or regions in other images captured at substantially the same time by other front-facing camera(s), and similarly for images captured by rear-facing cameras. The depth of pixels in the front and rear-facing images may then be estimated based on disparities between the positions of the matching pixels through triangulation. In alternative embodiments, other techniques such as LIDAR depth maps may be used in lieu of images captured by overlapping cameras.

In one embodiment, the track inspection application 210 may generate a 3D model, such as a point cloud, using the determined pixel depths. In turn, the track inspection application 210 may use the 3D model and known distances and GPS locations to make measurements of the track geometry. For example, the distance between the track rails may be measured by converting the distance in the 3D model to real-world distance based on a conversion factor. The conversion factor itself may be derived from, e.g., the known distance between front or rear-facing cameras and the expected versus observed disparity between images captured by those cameras. As another example, the GPS information captured along with the images may be used to determine if the entire track (or one of the rails) has moved relative to where it used to be. Other track geometry that the track inspection application 210 may measure include elevation, alignment, curvature, and so on.

At step 550, the track inspection application 210 detects anomalies in the track geometry based on a comparison of the determined track geometry to a stored track geometry. Similar to the reference images, the stored track geometry may be retrieved from a database, and the track inspection application 210 may compare such retrieved geometry information to the track geometry determined at step 240. Continuing the examples of distance between track rails and movement of the entire track (or one of the rails), the track inspection application 210 may compare the measured distance between track rails and the track's (or rail's) GPS coordinates with a stored distance and GPS coordinates, respectively, to determine whether the track distance and track (or rail) location are correct. Other track geometry measurements such as elevation, alignment, curvature, and the like, may similarly be compared with stored information to detect anomalies in such measurements.

At step 560, the track inspection application 210 generates and pushes to a handheld device a report detailing detected anomalies. As a result, a user of the handheld device may be notified of the detected anomalies and take appropriate remedial measures. For example, image(s) showing detected anomalies and associated GPS coordinates may be pushed to a mobile application running in the user's handheld device. In turn, the mobile application may display the received image(s), as well as a map with the GPS coordinates flagged so that the user can physically locate the detected anomalies. As described, a machine learning model, such a convolutional neural network, may also be trained to classify different types of anomalies in one embodiment, and, in such a case, the image analysis application 210 may use the trained machine learning model to classify the type of damage that each identified anomaly represents and include indications of those types of damages in the report that is generated and pushed to the handheld device.

Although described above primarily with respect to photographic cameras, in alternative embodiments, other types of sensors may be used in lieu of or in addition to photographic cameras. For example, thermal camera(s) may be used in one embodiment to capture the heat signature of railroad tracks, and such heat signatures may be compared with the heat signatures in reference thermal camera images to detect track damages. As another example, LIDAR may be used to capture distance measurements based on the reflections of pulsed laser light. Although described herein primarily with respect to railroad track anomalies and power line anomalies, alternative embodiments may also detect other types of anomalies that may appear in images captured by train-mounted cameras (or other sensors), such as changes to the environment on the sides of the railroad track that may be hazardous.

Advantageously, techniques disclosed herein provide an automated approach for detecting railroad track and power line anomalies. By capturing images (or other sensor data) with train-mounted cameras and analyzing such images (or other sensor data) according to techniques disclosed herein, railroad track and power line anomalies may be detected in essentially real-time during a train's normal operation. Further, the automated techniques disclosed herein are less labor-intensive than traditional manual inspections.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method for detecting anomalies affecting a railroad track, comprising:
receiving sensor data captured by one or more sensors mounted on a train, the sensor data being captured as the train traverses the railroad track;
normalizing the received sensor data to match corresponding reference sensor data; and
detecting the anomalies based, at least in part, on differences between the normalized sensor data and the corresponding reference sensor data.

2. The method of claim 1, wherein:
the sensor data includes a plurality of images captured by at least one camera mounted on the train; and
each image of the plurality of images is normalized to match a corresponding reference image captured from a substantially same location and vantage point as the image.

3. The method of claim 2, wherein the at least one camera includes a plurality of cameras with overlapping fields of view mounted on a front of the train and a plurality of cameras with overlapping fields of view mounted on a back of the train.

4. The method of claim 2, wherein the at least one camera includes at least one of a camera capturing images depicting the railroad track or a camera capturing images depicting one or more power lines above the railroad track.

5. The method of claim 1, further comprising:
determining a track geometry of the railroad track based, at least in part, on the normalized sensor data; and
detecting anomalies in the track geometry based, at least in part, on a comparison of the determined track geometry to a predefined track geometry.

6. The method of claim 5, wherein determining the track geometry includes:
determining depths of points in the normalized sensor data based, at least in part, on triangulation; and
generating a three-dimensional (3D) model based, at least in part, on the determined depths.

7. The method of claim 6, wherein detecting the anomalies in the track geometry includes comparing a distance between rails of the railroad track measured based, at least in part, on the 3D model and a distance between rails of the predefined track geometry.

8. The method of claim 6, wherein detecting the anomalies in the track geometry includes comparing a global positioning system (GPS) location of the railroad track with a GPS location of the predefined track geometry.

9. The method of claim 1, wherein the reference images are periodically updated.

10. The method of claim 1, wherein the reference images include standard images depicting railroad track components.

11. The method of claim 1, wherein the one or more sensors include at least one LIDAR (Light Detection and Ranging) sensor.

12. The method of claim 1, further comprising, pushing a report detailing the detected anomalies to an application running in a handheld device.

13. A non-transitory computer-readable storage medium storing instructions that, when executed by a processor, cause a computer system to perform operations for detecting railroad track anomalies, the operations comprising:
receiving sensor data captured by one or more sensors mounted on a train, the sensor data being captured as the train traverses the railroad track;
normalizing the received sensor data to match corresponding reference sensor data; and
detecting the anomalies based, at least in part, on differences between the normalized sensor data and the corresponding reference sensor data.

14. The computer-readable storage medium of claim 13, wherein:
the sensor data includes a plurality of images captured by at least one camera mounted on the train; and
each image of the plurality of images is normalized to match a corresponding reference image captured from a substantially same location and vantage point as the image.

15. The computer-readable storage medium of claim 14, wherein the at least one camera includes a plurality of cameras with overlapping fields of view mounted on a front of the train and a plurality of cameras with overlapping fields of view mounted on a back of the train.

16. The computer-readable storage medium of claim 14, wherein the at least one camera includes at least one of a camera capturing images depicting the railroad track or a camera capturing images depicting one or more power lines above the railroad track.

17. The computer-readable storage medium of claim 13, the operations further comprising:
determining a track geometry of the railroad track based, at least in part, on the normalized sensor data; and
detecting anomalies in the track geometry based, at least in part, on a comparison of the determined track geometry to a predefined track geometry.

18. The computer-readable storage medium of claim 13, wherein the reference images are either periodically updated or include standard images depicting railroad track components.

19. The computer-readable storage medium of claim 13, wherein the one or more sensors include at least one LIDAR (Light Detection and Ranging) sensor.

20. A system, comprising:
a processor; and
a memory configured to perform an operation for detecting railroad track anomalies, the operation comprising:
receiving sensor data captured by one or more sensors mounted on a train, the sensor data being captured as the train traverses the railroad track,
normalizing the received sensor data to match corresponding reference sensor data, and
detecting the anomalies based, at least in part, on differences between the normalized sensor data and the corresponding reference sensor data.
